(19) United States
(12) Patent Application Publication
(10) Pub. No.: US 2013/0194576 A1
(43) Pub. Date: Aug. 1, 2013

(54) OPTICAL PROBE FOR MEASURING ABSORPTION AT A PLURALITY OF WAVELENGTHS

(71) Applicants: Fabien Reversat, Aix En Provence (FR); Marc Hubert, Aix En Provence (FR); Stephane Tisserand, Marseille (FR); Laurent Roux, Marseille (FR)

(72) Inventors: Fabien Reversat, Aix En Provence (FR); Marc Hubert, Aix En Provence (FR); Stephane Tisserand, Marseille (FR); Laurent Roux, Marseille (FR)

(73) Assignee: SILIOS TECHNOLOGIES, PEYNIER (FR)

(21) Appl. No.: 13/811,106

(22) PCT Filed: Jul. 18, 2011
(86) PCT No.: PCT/FR2011/000420

§ 371 Date: Mar. 25, 2013

(30) Foreign Application Priority Data
Jul. 19, 2010 (FR) 1003015

(51) Int. Cl. G01N 21/59

(52) U.S. Cl. CPC G01N 21/59
USPC 356/436

(57) ABSTRACT

The invention relates to an optical probe including:
a first cell C1 including a first emitter module LED1 and a first detector module D1 suitable for producing a first detection signal;
a second cell C2 including a second detector module D2 suitable for producing a first monitoring signal for monitoring the first emitter module LED1; and
a control circuit for producing a first measurement signal by weighting the first detection signal by means of the first monitoring signal.

Furthermore, the second cell C2 has a second emitter module LED2, the second detector module D2 is suitable for producing a second detection signal, and the first detector module D1 is suitable for producing a second monitoring signal for monitoring the second emitter module LED2.

The present invention relates to an optical probe for measuring absorption at a plurality of wavelengths.

The field of the invention is that of using optical spectrometric analysis to analyze the absorption of a fluid medium, which may be gaseous or liquid.

Such analysis is performed by means of an optical probe that comprises an analysis cell having an emitter module and a detector module. The emitter module comprises a light source placed behind a diffusion window located in the body of the emitter module. A filter may optionally be arranged between the source and the diffusion window (monochromatic or quasi-monochromatic analysis). The detector module has a detector placed behind another window occupying the body of the detector module. Optionally, a filter is arranged between this other window and the detector. The medium for analysis lies between the emitter module and the detector module.

In known manner, analysis takes place in two stages. In a first stage, calibration consists in measuring the absorption of a reference medium. In a second stage, measurement proper consists in performing the same operation on the critical medium that is for analysis. The absorption of the critical medium is weighted by the absorption of the reference medium.

It is found that the emitter module suffers numerous kinds of drift that continue to increase during its lifetime. Mention may be made in particular of the following:
variation in the temperature of the critical medium;
variation in the power of the emitter source;
variation in the angular profile of the beam emitted by the source;
variation in the emission spectrum; and
light noise appearing, and then increasing.

These kinds of drift cannot be controlled, and they often occur in random manner. It is not possible to estimate when they will become sufficiently large to disturb analysis. Unfortunately, each of these kinds of drift requires new calibration in order to have measurements available that are taken under the same conditions both in the reference medium and in the critical medium. Calibrations must therefore be repeated periodically, and it goes without saying that that can be a serious constraint.

Thus, document FR 2 939 894 proposes an optical probe for measuring absorption, which probe has a first cell, or analysis cell, that comprises both an emitter module and a detector module suitable for producing a detection signal. That optical probe also has a second cell, or monitoring cell, that is suitable for producing a monitoring signal, the monitoring cell being arranged on the light path between the emitter module and the detector module.

When analysis is to be performed at a single wavelength, that probe is satisfactory. However, when it is appropriate to perform analysis at a plurality of wavelengths, it is necessary to provide a respective probe for each wavelength.

An object of the present invention is thus to provide an optical probe that enables absorption to be measured at a plurality of wavelengths by means of two cells.

According to the invention, an optical probe comprises:
a first cell comprising a first emitter module and a first detector module suitable for producing a first detection signal;
a second cell comprising a second detector module suitable for producing a first monitoring signal for monitoring the first emitter module; and
a control circuit for producing a first measurement signal by weighting the first detection signal by means of the first monitoring signal;

furthermore, the second cell has a second emitter module, the second detector module is suitable for producing a second detection signal, and the first detector module is suitable for producing a second monitoring signal for monitoring the second emitter module.

Commonly, each of the cells is in the form of a sealed body having an active face.

Advantageously, each cell is arranged behind a respective window located in its active face.

According to an additional characteristic, each of the detector modules is placed behind a respective partially-reflective plate adjacent to the corresponding window.

Preferably, the detectors are identical.

Furthermore, the cells are connected together by connection means, and the active faces of the cells face each other.

By way of example, the first measurement signal Qm is equal to the ratio of the detection signal divided by the monitoring signal.

Advantageously, the control circuit stores the following values in memory:
a reference measurement Qr;
a reference absorption Ar; and
a characteristic length Lc;
   with the term Ln designating the natural logarithm, the control circuit produces an absorption value Am that is derived from the following expression:

Am=Ar−(Ln(((Qm−Qr)/Qr)+1)/Lc)

Preferably, the control circuit is provided with temperature compensation.

By way of example, the temperature compensation is performed by means of two constants K1 and K2, by means of a calibration temperature θ₀, and by means of the temperature θ at which the measurement is taken, by using the following expression:

Qm(θ)/Qr(θ₀)=exp((Ar−Am).Lc).(θ+K1)/(θ₀+K1).(θ₀+K2)/(θ+K2)

In a variant embodiment, one of the emitter modules includes two sources illuminating the detector module facing it via a partially-reflective plate.

The present invention appears below in greater detail in the context of the following description of an embodiment given by way of illustration and with reference to the accompanying figures, in which:

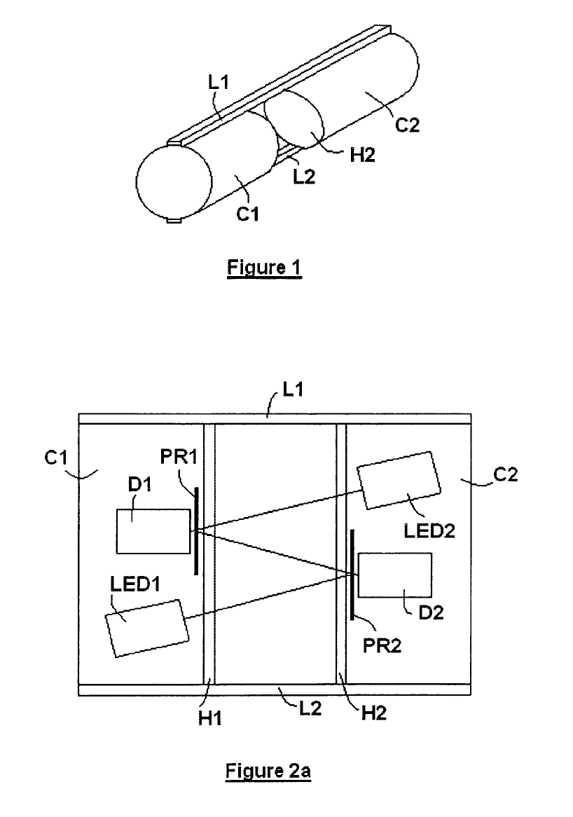

FIG. 1 is a perspective view of an optical probe for measuring absorption;

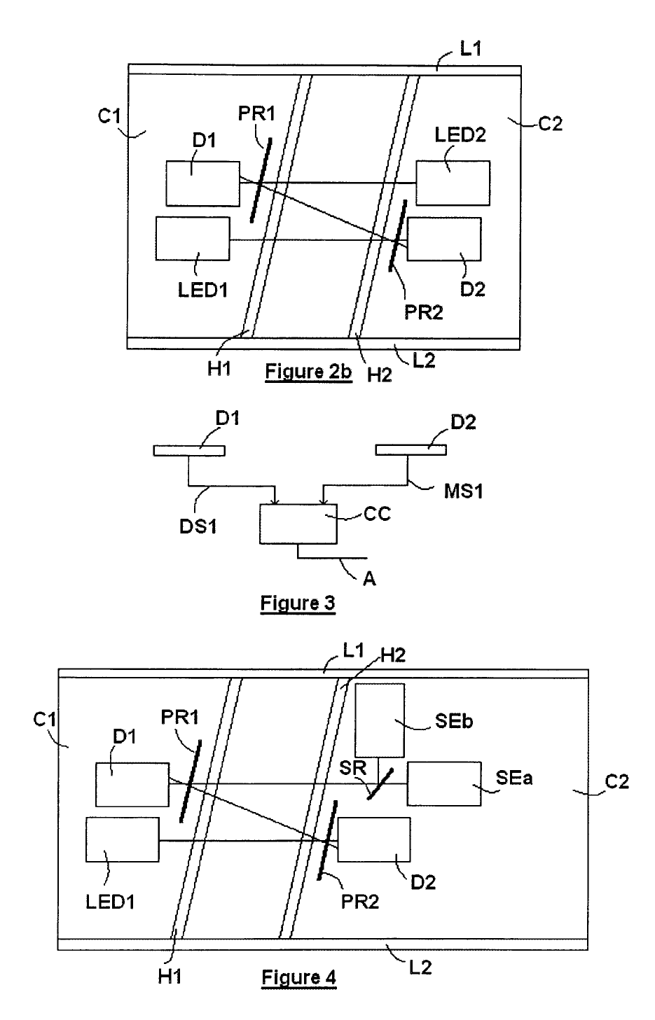

FIG. 2 is a diagram in section showing the mechanical layout of the optical probe, and in particular:

FIG. 2a shows a first option; and

FIG. 2b shows a second option;

FIG. 3 is a diagram of the electric circuit of the optical probe; and

FIG. 4 is a diagram in section of a variant of the optical probe.

Elements present in more than one of the figures are given the same references in each of them.

With reference to FIG. 1, the optical probe is in the form of two distinct elements, a first cell C1 and a second cell C2. In the present example, each of these two cells is in the form of a cylindrical body. They are connected together by connection means that are in the form of a top bar L1 and a bottom bar L2. The connection is performed in such a manner that both cylindrical bodies share the same axis. The facing faces of the two cylindrical bodies are referred to below as their “active” faces. Naturally, the medium that is to be analyzed is to be found between these two active faces.

With reference to FIG. 2a, in a first option, the first cell C1 essentially comprises a first emitter module LED1, e.g. a light-emitting diode (LED), and a first detector module D1.

These two first modules LED1 and D1 are arranged behind a first window H1 that embodies the active face of the first cell C1. Depending on the nature of the source, it may be necessary to provide a bandpass filter between the source and the window H1. If the emitter module is an LED that presents a relatively narrow emission spectrum, then it is not always necessary to have a filter.

The first detector module has a first detector D1 that is arranged behind the first window H1 in the vicinity of the first emitter module LED1. A first partially-reflective plate PR1 is interposed between the first window H1 and the first detector D1. This plate may equally well be incorporated in the window.

In analogous manner, the second cell C2 comprises a second emitter module LED2 and a second detector module D2.

These two second modules LED2 and D2 are arranged behind a second window H2 that embodies the active face of the second cell C2.

The second detector module has a second detector D2 that is arranged behind the second window H2 in the vicinity of the second emitter module LED2. A second partially-reflective plate PR2 is interposed between the second window H2 and the second detector D2.

Naturally, since the medium for analysis is a fluid, the cells C1 and C2 are sealed. Each of them is thus provided with a wall at its end opposite from its active face.

In the above description, it is assumed implicitly that the bodies of these cells are opaque to the radiation used for analysis. This should not be seen as being a limitation on the invention, since the invention also applies when the body is transparent to that radiation. It can thus be understood that the term “window” should be understood broadly, i.e. as a transparent surface.

Preferably, in order to optimize the performance of the probe, the second detector D2 is identical to the first detector D1. Likewise, the two windows H1 and H2 are of the same kind.

The mechanical arrangement of the probe is such that the light beam coming from the first emitter module LED1 passes in succession through the first window H1, through the medium for analysis, and then through the second window H2. This beam then reaches the second partially-reflective plate PR2 where part of it is transmitted to the second detector D2 and where part of it is reflected towards the first window H1 so as finally to pass through the first partially-reflective plate PR1 and reach the first detector D1.

Likewise, the light beam from the second emitter module LED2 passes in succession through the second window H2, the medium for analysis, and then the first window H1. This beam then reaches the first partially-reflective plate PR1 where part of it is transmitted to the first detector D1 and part of it is reflected to the second window H2 where it finally passes through the second partially-reflective plate PR2 and reaches the second detector D2.

In this example, the windows H1 and H2 are substantially perpendicular to the axis of the probe. This configuration makes it possible to illuminate both detectors D1 and D2 with both of the emitter modules LED1 and LED2 by placing the detectors parallel to the axis of the probe and by inclining the emitter modules relative to the axis.

Thus, the second detector D2 lies on the light path connecting the first emitter module LED1 to the first detector D1. Similarly, the first detector D1 lies on the light path connecting the second emitter module LED2 to the second detector D2.

With reference to FIG. 3, there follows a description of the electric circuit of the optical probe and of the way in which absorption is measured in the reception band of the first detector D1, assuming that only the first emitter module LED1 is activated.

A control circuit CC receives:
a first detection signal DS1 from the first detector Dl; and
a first monitoring signal MS1 from the second detector D2.

It produces an absorption coefficient A or any intermediate value that enables the coefficient to be obtained.

The following notation is adopted below:
I0, the intensity emitted by the first emitter module LED1.
I1, the intensity received by the first detector D1, represented by the first detection signal DS1;
I2, the intensity received by the second detector D2, represented by the first monitoring signal MS1;

R, the coefficient of reflection of the second window H2;
T, the coefficient of transmission of the second window H2;
G2, the attenuation coefficient between the first emitter module LED1 and the second window H2;
G1, the attenuation coefficient between the first emitter module LED1 and the first window H1;
Lc, the distance between the two windows H1 and H2;
A, the absorption coefficient, more particularly Ar, which is this coefficient in the reference medium (stored in the control circuit CC) and Am, which is this coefficient in the medium for analysis;
exp, the exponential function; and
Ln, the natural logarithm.

The attenuation coefficients take account of the fact that the detectors do not receive all of the light flux emitted towards them. The attenuation coefficients thus depend on geometrical considerations and are independent of the absorption coefficients, while the absorption coefficients depend on the physicochemical properties of the medium being analyzed.

The intensity received by the second detector is given by:

I2=I0.T.G2.exp(−A.Lc)

The intensity received by the first detector is given by:

I1=I0.R.G1.exp(−2A.Lc)

It should be emphasized at this point that in order to optimize the sensitivity of the probe, the second window H2 is designed so that both of the intensities I2 and I1 are of similar magnitudes. The partial reflection by this window may be obtained in various ways, and in particular by:
coating with a fine thickness of metal;
a layer of opaque and reflecting metal having openings arranged therein as a checkerboard, in rows, . . . ;
a mirror having a central opening;
a dielectric mirror; and/or
a mirror covering part of the window.

The measurement Q is thus defined as the ratio of the intensity received by the first detector D1 divided by the intensity received by the second detector D2:

Q=I1/I2

Q=((R.G1)/(T.G2)).exp(−A.Lc)

The expression (R.G1)/(T.G2) is a constant that can be written K:

Q=K.exp(−A.Lc)

It can be seen that it is only the distance Lc between the two windows H1 and H2 that is involved, and this is therefore the characteristic length of the optical probe.

This characteristic length Lc is stored in the control circuit CC.

Calibration in the reference medium gives the reference measurement Qr:

Qr=K.exp(−Ar.Lc)

This reference measurement is also stored by the control circuit CC.

The measurement in the medium for analysis gives the measurement signal Qm:

Qm=K.exp(−Am.Lc)

From which it follows:

(Qm−Qr)/Qr=exp((Ar−Am).Lc)−1

The control circuit thus produces the looked-for absorption coefficient Am:

Am=Ar−(Ln(((Qm−Qr)/Qr)+1)/Lc) [1]

Other means are available for obtaining the absorption coefficient Am of the medium for analysis. By way of example, it is possible to calculate directly the ratio of the measurement signal Qm over the reference measurement Qr:

Qm/Qr=exp((Ar−Am).Lc)

whence:

Am=Ar−(Ln(Qm/Qr)/Lc) [2]

Equations [1] and [2] are equivalent, and the invention applies to any solution derived from the above-explained principle.

Temperature compensation may optionally be provided in order to take account of the fact that calibration and measurement proper are not performed at the same temperature.

It is assumed that intensities vary in linear manner as a function of temperature θ, with these variations being quantified by means of four constants α, β, χ, and δ:

The intensity received by the second detector D2 is now given by:

I2(θ)=I0.T.G2.exp(−A.Lc).(χθ+δ) [3]

The intensity received by the first detector is given by:

I1(θ)=I0.R.G1.exp (−2A.Lc).(αθ+β) [4]

The measurement Q(θ) always gives the ratio of the intensity received by the first detector D1 to the intensity received by the second detector D2:

Q(θ)=I1(θ)/I2(θ)

Q(θ)=K.exp(−A.Lc).(αθ+β)/(χθ+δ)

Calibration is thus performed in a reference medium of known absorption at a calibration temperature θ₀:

Q(θ₀)=K.exp(−Ar.Lc).(αθ₀+β)/(χθ₀+δ)

The measurement in the medium for analysis at the temperature θ gives the measurement signal Qm(θ):

Qm(θ)=K.exp(−Am.Lc).(αθ+β)/(χθ+δ)

From which it follows:

Qm(θ)/Qr(θ₀)=exp((Ar−Am).Lc).(αθ+β)/(χθ+δ).(χθ₀+δ)/(αθ₀+β)

Qm(θ)/Qr(θ₀)=exp((Ar−Am).Lc).(θ+β/α)/(θ₀+β/α).(θ₀+δ/χ)/(θ+δ/χ)

The constants β/α and δ/χ are determined experimentally. For a liquid in which absorption does not vary with temperature, the characteristic of the intensity I1 (θ) received by the first detector D1 as a function of temperature θ is established by means of two constants a and b:

I1(θ)=aθ+b

Using this equation with equation [4], it follows that:

a=I0.R.G1.exp(−2A.Lc).α

b=I0.R.G1.exp(−2A.Lc).β

The ratio K1=β/α is easily deduced therefrom, which ratio is equal to the ratio b/a.

The same procedure is then used to establish the characteristic of the intensity I2 (θ) received by the second detector D2 as a function of temperature θ in order to obtain the ratio K2=δ/χ.

These two ratios K1 and K2 characterizing temperature variations are stored in the control circuit CC, as is the calibration temperature θ₀. Furthermore, a sensor (not shown) informs the control circuit CC about the temperature θ at which the measurement is being taken.

The person skilled in the art is well aware that the two cells C1 and C2 are symmetrical. Thus, there is no need to describe in detail how to measure absorption in the reception band of the second detector D2, which is performed by assuming that only the second emitter module LED2 is activated.

In order to measure absorption on each detector, it is necessary to avoid having both emitter modules acting simultaneously on the detectors.

A first solution consists in activating the emitter modules sequentially.

A second solution consists in modulating the emitter modules at two different frequencies. The detectors, each tuned to a respective one of these frequencies, are then used to perform synchronous detection, a technique that is well known to the person skilled in the art.

Generally, the detectors are centered on two distinct wavelengths. The invention also applies if they have the same spectral response, thereby procuring redundancy.

With reference to FIG. 2b, in a second option, the required geometrical configuration is obtained by inclining the windows H1 and H2 relative to the axis of the probe and by placing the two detectors D1 and D2 and the two emitter modules LED1 and LED2 parallel to the axis. The description given with reference to FIG. 2a applies without modification.

With reference to FIG. 4, a variant of the probe is described that enables the spectral extent to be further increased.

The first cell C1 is arranged as in the second option described with reference to FIG. 2b.

The second cell C2 still comprises a second detector module D2 identical to that described above, but the second emitter module is different.

These two second modules are still arranged behind the second window H2.

The second emitter module in this variant is constituted by first and second light sources SEa and SEb that illuminate a semi-reflective plate SR. The geometrical configuration is such that the beam from the first source SEa passes through the semi-reflective plate SR so as to reach the first detector D1 and the beam from the second source SEb is reflected by the plate SR likewise towards the first detector D1.

In general, the two light sources are centered on two distinct wavelengths. The invention also applies if they emit the same spectrum, thus making it possible to mitigate a failure of one of the sources.

Thus, if the two light sources are centered on two distinct wavelengths, it is also necessary to avoid powering them simultaneously.

The optical probe of the present invention measures absorption by comparing the optical properties of a critical medium with the optical properties of a reference medium.

Calibration is performed once and for all prior to putting the probe into operation, since the monitoring cell makes it possible to avoid being affected by the various kinds of drift mentioned above in the introduction. Calibration may optionally be performed from time to time, if only for safety reasons.

An additional advantage of the present invention lies in the fact that both cells may be identical. This leads to a very small number of probe subassemblies, which facilitates fabrication.

The embodiments of the invention described above have been selected because of their concrete nature. Nevertheless, it is not possible to list exhaustively all possible embodiments covered by the invention. In particular, any means described may be replaced by equivalent means without going beyond the ambit of the present invention.

1. An optical probe comprising:
a first cell (C1) comprising a first emitter module (LED1) and a first detector module (D1) suitable for producing a first detection signal (DS1);
a second cell (C2) comprising a second detector module (D2) suitable for producing a first monitoring signal (MS1) for monitoring the first emitter module (LED1); and
a control circuit (CC) for producing a first measurement signal (Qm1) by weighting said first detection signal (DS1) by means of said first monitoring signal (MS1);
the probe being characterized in that said second cell (C2) has a second emitter module (LED2, SR-SEa-SEb), said second detector module (D2) is suitable for producing a second detection signal, and said first detector module (D1) is suitable for producing a second monitoring signal for monitoring said second emitter module (LED2, SR-SEa-SEb).

2. An optical probe according to claim 1, characterized in that each of said cells (C1, C2) is in the form of a sealed body having an active face.

3. An optical probe according to claim 2, characterized in that each of said cells (C1, C2) is arranged behind a respective window (H1, H2) located in its active face.

4. An optical probe according to claim 3, characterized in that each of said detector modules (D1, D2) is placed behind a respective partially-reflective plate (PR1, PR2) adjacent to the corresponding window (H1, H2).

5. An optical probe according to claim 4, characterized in that said detectors (D1, D2) are identical.

6. An optical probe according to claim 5, characterized in that said cells (C1, C2) are connected together by connection means (L1, L2), and the active faces of the cells face each other.

7. An optical probe according to claim 1, characterized in that said first measurement signal Qm is equal to the ratio of said detection signal (DS1) divided by said monitoring signal (MS1).

8. An optical probe according to claim 7, characterized in that said control circuit (CC) stores the following values in memory:
a reference measurement Qr;
a reference absorption Ar; and
a characteristic length Lc;
with the term Ln designating the natural logarithm, the control circuit produces an absorption value Am that is derived from the following expression:
Am=Ar−(Ln(((Qm−Qr)/Qr)+1)/Lc)

9. An optical probe according to claim 8, characterized in that said control circuit (CC) is provided with temperature compensation.

10. An optical probe according to claim 9, characterized in that said temperature compensation is performed by means of two constants K1 and K2, by means of a calibration temperature θ₀, and by means of the temperature θ at which the measurement is taken, by using the following expression:
Qm(θ)/Qr(θ₀)=exp((Ar−Am).Lc).(θ+K1)/(θ₀+K1).(θ₀+K2)/(θ+K2)

11. An optical probe according to claim 1, characterized in that one of said emitter modules includes two sources (SEa, SEb) illuminating the detector module (D1) facing it via a partially-reflective plate (SR).
